(19) United States
(12) Patent Application Publication
(10) Pub. No.: US 2023/0099825 A1
(43) Pub. Date: Mar. 30, 2023

(54) POWER SUPPLY DEVICE, METHOD AND SECURE SYSTEM

(71) Applicant: NUVOTON TECHNOLOGY CORPORATION, HSINCHU CITY (TW)

(72) Inventors: WEI-CHAN HSU, Cupertino, CA (US); PO-HSUAN HUANG, HSINCHU CITY (TW); CHUNG MING HSIEH, HSINCHU CITY (TW)

(21) Appl. No.: 17/951,517

(22) Filed: Sep. 23, 2022

Related U.S. Application Data
(60) Provisional application No. 63/248,664, filed on Sep. 27, 2021.

(30) Foreign Application Priority Data
Apr. 25, 2022 (TW) 111115605

(51) Int. Cl. H02J 7/00; H02J 7/34; G06F 21/81

(52) U.S. Cl. CPC H02J 7/00712; H02J 7/345; G06F 21/81

(57) ABSTRACT

A power supply device is provided with a secure power supply device, a voltage detection circuit, a stable voltage source and a switch. By using the voltage detection circuit, whether a driving voltage of an encryption/decryption device is insufficient to control the on and off the switch, so as to determine whether only the secure power supply device provides a supply voltage to the encryption/decryption device as the driving voltage. Alternatively, the supply voltage of the secure power supply device and a stable voltage of the stable voltage source are provided simultaneously to the encryption/decryption device as the driving voltage. In other words, once the driving voltage drops (that is, the encryption/decryption device consumes a large current for encryption/decryption), the stable voltage source immediately provides the stable voltage to the encryption/decryption device as part of the driving voltage to ensure that the encryption/decryption device can normally work.

### CROSS-REFFERENCE TO RELATED APPLICATION

This application claims the priority from the U.S. Patent Application No. 63/248,664, filed on Sep. 27, 2021, and TW Patent Application No. 111115605, filed on Apr. 25, 2022, and all contents of such US and TW Patent Applications are included in the present disclosure.

### BACKGROUND

### 1. Field of the Invention

The present disclosure relates to a power supply device, a method and a secure system, in particular to, a power supply device, a method and a secure system that are capable of preventing hackers from maliciously stealing secure information by detecting variations of a system voltage and a corresponding current of the power supply device.

### 2. Description of the Related Art

In recent years, security applications have implemented in many fields, including ID (identification) cards, credit cards, computer access control, and mobile phones (such as SIM (subscriber identity module) cards). These application programs often rely on cryptographic computations based on sensitive data or keys embedded in memory for high security. Hackers may try to extract the sensitive data or keys from the cards to generate unauthorized transactions. Side attacks are most common method of gathering information from a card or a computer system during normal operation. The side attacks may decrypt the keys according to clock signals, power consumption, and electromagnetic field. Therefore, keeping data safe and avoiding side attacks are factors that need to be considered when designing a secure system.

The case of the side attacks on the power supply is described as follow. The hacker detects a current change and power supply characteristics caused by the current change during the switching of logic gates of an encryption/decryption device, which are implemented by multiple logic gates. Usually, a driving voltage applied to the encryption/decryption device also changes with the current change. These power supply characteristics can be monitored through power pins and used to recover the sensitive data or keys. In order to prevent from reading signals of the power supply and grounds of the logic gates, the power pins and the ground pins are isolated from external pads.

Referring to FIG. 1, which is a circuit diagram of a secure system in prior art. A secure system 1 comprises a power source 10, a power supply device 12 and an encryption/decryption device 14. The power supply device 12 is electrically connected between the power source 10 and the encryption/decryption device 14, so as to prevent hackers from obtaining power characteristics related to secure information by detecting power pins and ground pins of the power supply 10. The power supply device 12 comprises a plurality of switches SW1-SW5 and a charge storage capacitor CS. One end of the switch SW1 is electrically connected a system voltage of the power source 10. Other one end of the switch SW1 is electrically connected to one end of the switch SW2, one end of the switch SW5 and one end of the charge storage capacitor CS. Other one end of the switch SW2 is electrically connected to one end of the encryption/decryption device 14, so as to output a supply voltage to the encryption/decryption device 14 as a driving voltage of the encryption/decryption device 14. One end of the switch SW3 is electrically connected to a ground voltage of the power source 10. Then, other one end of the switch SW3 is electrically connected to one end of the switch SW4, other one end of the switch SW5 and other one end of the charge storage capacitor CS. Other one end of switch SW4 is electrically connected to other one end of the encryption/decryption device 14 to provide a ground voltage to the encryption/decryption device 14.

The process of providing the supply voltage from the power supply device 12 in the above-mentioned conventional system is as follow. Firstly, in the first stage, only the switch SW5 is turned on, and the other switches SW1-SW4 are turned off to make the charge storage capacitor CS discharge to a specific voltage level. That is, the switch SW5 is configured as a reset switch. In the second stage, the switches SW1 and SW3 are turned on, and the other switches SW2, SW4 and SW5 are turned off. Hence, the system voltage of the power source 10 charges the charge storage capacitor CS. Also, the third stage is entered only after charging to the voltage level of the system voltage. In the third stage, the switches SW2 and SW4 are turned on, the other switches SW1, SW3 and SW5 are turned off. The charge storage capacitor CS provides the supply voltage to the encryption/decryption device 14 as the is driving voltage. Then, in the fourth stage, the encryption/decryption device 14 is permitted to perform encryption/decryption. After the fourth stage, the process returns to the first stage again.

Through the above-mentioned conventional solution, it is possible to prevent hackers from obtaining the power characteristics related to secure information by detecting the power pins and the ground pins of the power source 10. However, the above-mentioned conventional solution has to ensure that the amount of charge stored in the charge storage capacitor CS must be able to supply a large amount of charge consumed by the encryption/decryption device 14 during encryption/decryption. For this reason, a size of the charge storage capacitor CS must be sufficiently large. Further, the above-mentioned conventional solution is not a power saving solution because the above-mentioned conventional solution has to discharge the charge storage capacitor CS to a predetermined voltage level in the first stage. In addition, the larger size of the charge storage capacitor CS causes the longer charging and discharging time, and the whole process is more time-consuming. Needless to say, the conventional solution requires a total of the four stages to ensure that the encryption/decryption device 14 can normally work.

### SUMMARY

An embodiment of the present disclosure provides a power supply device, configured to provide power to an encryption/decryption device of a secure system. The power supply device comprises a secure power supply device, a stable voltage source, a voltage selection device, and a switch. The secure power supply device is configured to provide a supply voltage based on a system voltage. The stable voltage source is configured to provide a stable voltage. The voltage selection device is electrically connected to the is encryption/decryption device, the secure power supply device and the stable voltage source. The voltage selection device is configured to select both of the stable voltage and the supply voltage as a driving voltage of the encryption/decryption device when the driving voltage of the encryption/decryption device is lower than a lower limit voltage. Also, the voltage detection circuit is configured to select the supply voltage as the driving voltage when the driving voltage of the encryption/decryption device is not lower than the lower limit voltage.

An embodiment of the present disclosure provides a secure system. The secure system comprises the preceding power supply device and the encryption/decryption device.

An embodiment of the present disclosure further provides a power supply method. The power supply method is configured to provide power to an encryption/decryption device of a secure system, and has the following steps. Determine whether a driving voltage of the encryption/decryption device is lower than a lower limit voltage. When the driving voltage of the encryption/decryption device is lower than the lower limit voltage, use both of a supply voltage provided by the secure power supply device and a stable voltage provided by a stable voltage source as the driving voltage. Alternatively, when the driving voltage of the encryption/decryption device is not lower than the lower limit voltage, use the supply voltage as the driving voltage.

As the state above, compared with the related art, the power supply devices, the method and the secure system provided by the embodiments of the present disclosure is able to achieve at least one of the technical effects of reducing size, operation time, power consumption and circuit area required for the charge storage capacitor. The power supply device of the embodiments of the present disclosure can effectively protect the secure system, and prevent hackers from obtaining secure information through the power characteristics detected by the power pins and the ground pins.

To further understand the technology, means, and effects of the present disclosure, reference may be made by the detailed description and drawing as follows. Accordingly, the purposes, features and concepts of the present disclosure can be thoroughly and concretely understood. However, the following detail description and drawings are only used to reference and illustrate the implementation of the present disclosure, and they are not used to limit the present disclosure.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a circuit diagram of a secure system according to a related art;

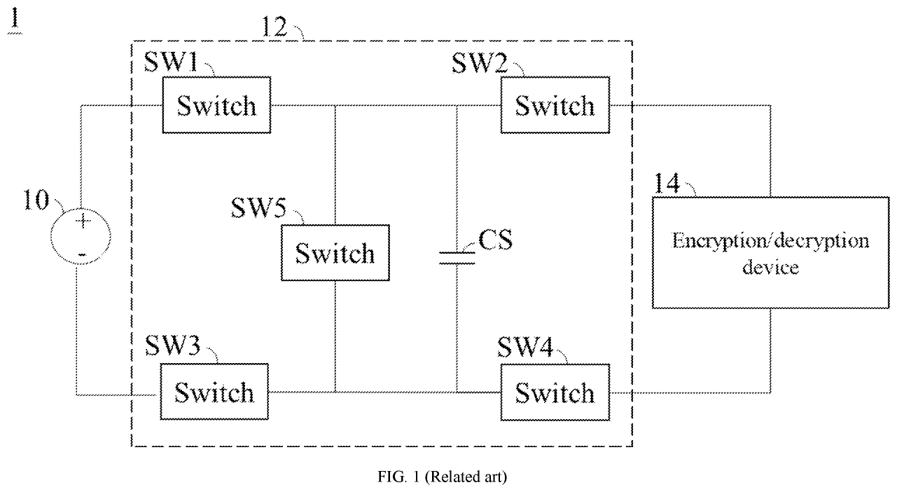

FIG. 2 is a circuit diagram of a secure system according to an embodiment of the present disclosure;

FIG. 3 is a circuit diagram of a secure power supply device according to an embodiment of the present disclosure;

FIG. 4 is another circuit diagram of a secure power supply device according to an embodiment of the present disclosure;

FIG. 5 is a flowchart of a power supply method according to an embodiment of the present disclosure;

FIG. 6 is a circuit diagram of a stable voltage source according to an embodiment of the present disclosure.

### DESCRIPTION OF THE PREFERRED EMBODIMENTS

The embodiments of the present disclosure are described in detail as reference, and the drawings of the present disclosure are illustrated. In the case of possibility, the element symbols are used in the drawings to refer to the same or similar components. In addition, the embodiment is only one approach of the implementation of the design concept of the present disclosure, and the following multiple embodiments are not intended to limit the present disclosure.

To solve the problems of the related art, various power supply devices, a method and a secure system provided by embodiments of the present disclosure are used to prevent hackers from obtaining secure information through power characteristics by power pins and ground pins. Besides, when the secure protection effect is achieved, at least one of the technical effects of reducing the required size, operation time, power consumption current and circuit area for a charge storage capacitor is also achieved.

In an embodiment of the present disclosure, a power supply device comprises a secure power supply device, a voltage detection circuit, a stable voltage source and a switch. By determining whether a driving voltage of an encryption/decryption device is insufficient to control the on and off the switch, so as to determine whether only provides a supply voltage generated by the secure power supply device to the encryption/decryption device as the driving voltage. Alternatively, both of the supply voltage provided by the secure power supply device and a stable voltage provided by the stable voltage source are provided simultaneously to the encryption/decryption device as the driving voltage. In other words, once the driving voltage drops (that is, the encryption/decryption device consumes a large current for encryption/decryption), the stable voltage source (for example, realized by DC-DC conversion apparatus such as bandgap generators, low-dropout regulators, etc.) immediately provides the stable voltage to the encryption/decryption device as part of the driving voltage to ensure that the encryption/decryption device can normally work. Since the voltage detection circuit detects the encryption/decryption device in real time, it is not necessary for the secure power supply device to perform the four-stage charging and discharging in the related art. Therefore, the required size, operation time, current consumption and circuit area of the charge storage capacitor are effectively reduced.

By the way, the above switch and the above voltage detection circuit may be integrated into a voltage selection device. The voltage selection device is electrically connected to the encryption/decryption device, the secure power supply device and the stable voltage source. The voltage selection device selects the supply voltage as the driving voltage when the driving voltage of the encryption/decryption device is not lower than the lower limit voltage. Also, the voltage selection device selects simultaneously the supply voltage and the stable voltage as the driving voltage when the driving voltage of the encryption/decryption device is lower than the lower limit voltage. Furthermore, in another embodiment, it may also be designed that the voltage selection device only selects the stable voltage as the driving voltage when the driving voltage of the encryption/decryption device is lower than the lower limit voltage.

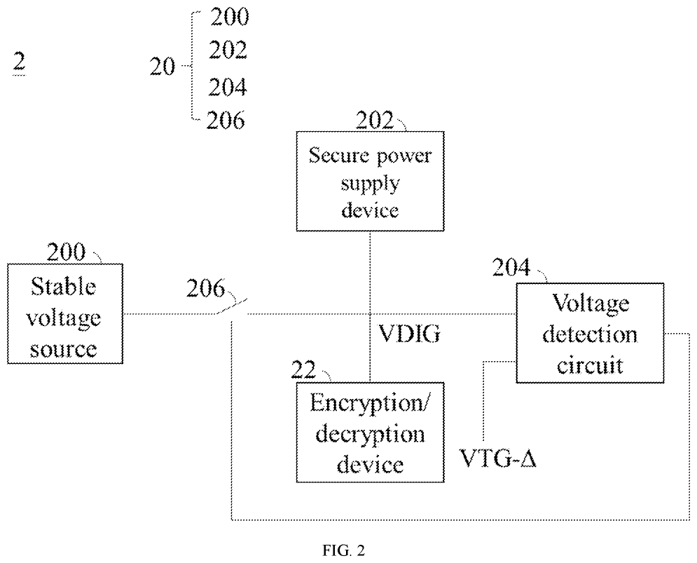

Firstly, referring to FIG. 2, FIG. 2 is a circuit diagram of a secure system according to an embodiment of the present disclosure. A secure system 2 comprises a power supply device 20 and an encryption/decryption device 22. The power supply device 20 comprises a stable voltage source 200, a secure power supply device 202, a voltage detection circuit 204 and a switch 206. The power supply device 20 is configured to provide power to the encryption/decryption device 22, of which main purpose is to prevent hackers from obtaining secure information by detecting changes in power characteristics (i.e. changes in the power characteristics of a system voltage) get from power pins and ground pins. Namely, during encryption/decryption processes by the encryption/decryption device 22, the power characteristics will not be changed significantly.

The secure power supply device 202 is configured to generate a supply voltage based on the system voltage and provide the supply voltage. Besides, the supply voltage is applied to the encryption/decryption device 22 as part or all of a driving voltage VDIG for driving the encryption/decryption device 22 (related to whether the switch 206 is turned on or off). Through the secure power supply device 202, a variation amount of the power characteristics of the system voltage is less than a specific amount when the encryption/decryption device 22 performs encryption/decryption. For instance, a current or voltage variation amount is less than 5%, but the present disclosure is not limited thereto. However, when simply the secure power supply device 202 provides the supply voltage as the driving voltage VDIG of the encryption/decryption device 22, it may be not able to provide enough total output current to the encryption/decryption device 22 as the current consumed by the encryption/decryption device 22 (if the secure power supply device 202 does not have a large charge storage capacitor or sufficient switching current units). Thus, the stable voltage source 200, the switch 206 and the voltage detection circuit 204 are disposed in the power supply device 20 to solve the preceding technical problems.

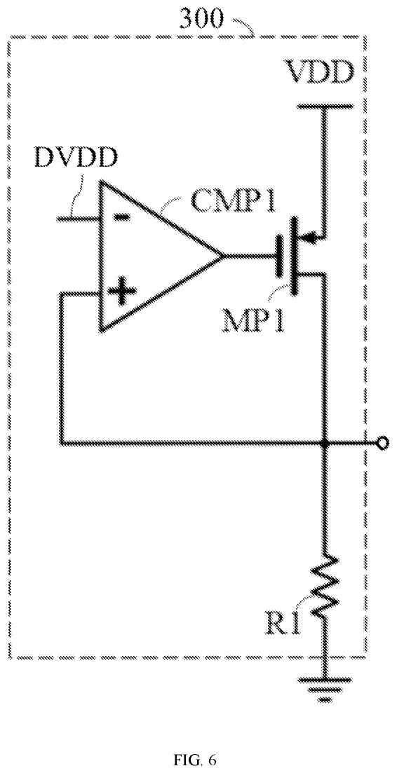

The stable voltage source 200 is configured to provide the stable voltage that is not susceptible to fluctuations. Also, the stable voltage source 200 may be realized by DC-DC conversion apparatus such as bandgap generators, low-dropout regulators, etc. For example, but without limitation, an embodiment of the present disclosure is realized by a stable voltage source 300 of the FIG. 6, which is implemented by a bandgap reference voltage circuit comprising a PMOS transistor MP1, a comparator CMP1 and a resistor R1. As well, the stable voltage source 300 is configured to provide a lower system voltage DVDD (lower than a system voltage VDD) as the stable voltage. The voltage detection voltage 204 is electrically connected to the encryption/decryption device 22. The voltage detection voltage 204 is configured to generate a switch signal based on the driving voltage VDIG of the encryption/decryption device 22. Further, the voltage detection circuit 204 may be implemented by using a comparator. The comparator is configured to receive the driving voltage VDIG of the encryption/decryption device 22. A positive input end of the comparator is configured to receive a lower limit voltage VTG-Δ, and a voltage value of the lower limit voltage VTG-Δ is a target voltage value VTG of the driving voltage VDIG minus a difference voltage value Δ. It should be noted that the implementation of the voltage detection circuit 204 of the present disclosure is not limited by the comparator. The switch 206 has a first end, a second end and a control end. The first end of the switch 206 is electrically connected to the stable voltage source 200, the second end of the switch 206is electrically connected to the encryption/decryption device 22, and the control end of the switch 206 is electrically connected to the voltage detection circuit 204 to receive a first switch signal. The turning on or off of the switch 206 (i.e. the conduction or disconnection of the first end and the second end) is controlled by the first switch signal.

When the encryption/decryption device 22 performs encryption/decryption, the current consumption of the encryption/decryption device 22 increases and the driving voltage VDIG of the encryption/decryption device 22 decreases. When the driving voltage VDIG is lower than the lower limit voltage VTG-Δ, the first switch signal makes the switch 206 turn on. At present, the encryption/decryption device 22 receives the stable voltage and the supply voltage as the driving voltage VDIG. Namely, the driving voltage consists of two parts, one of which is the stable voltage and the other is the supply voltage. In this way, it may be ensured that the encryption/decryption device 22 has enough current available to perform encryption/decryption normally.

When the driving voltage VDIG is still greater than the lower limit voltage VTG-Δ, the first switch signal makes the switch 206 turn off. Hence, the supply voltage is still provided by the secure power supply device 202 as the whole of the driving voltage VDIG. Preferably, the secure power supply device 202 is designed to increase the total output current of the secure power supply device 202 to increase a voltage value of the driving voltage VDIG when the driving voltage VDIG decreases but is still greater than the lower limit voltage VTG-Δ.

By the way, the power supply device 20 may further comprise a capacitor connected in parallel with the encryption/decryption device 22 and/or a ripple suppression unit (not shown in figures) connected in parallel with the encryption/decryption device 22. By using the design that the capacitor is connected in parallel with the encryption/decryption device 22 and/or the ripple suppression unit is connected in parallel with the encryption/decryption device 22, the stability of the driving voltage can be more effectively maintained. Besides, the ripple suppression unit can be a transistor of which a gate receives a fixed bias voltage. A source of the transistor receives the driving voltage VDIG, and a drain of the transistor receives a low voltage (such as a ground voltage). Therefore, a ripple may be reduced when the driving voltage changes.

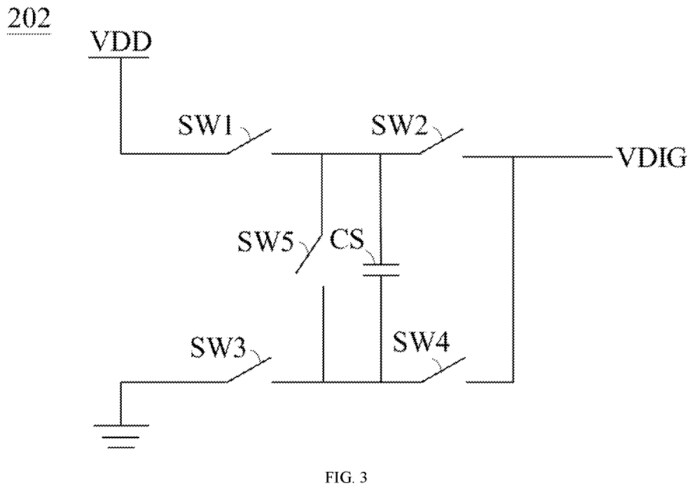

Next, referring to FIG. 3, FIG. 3 is a circuit diagram of a secure power supply device according to an embodiment of the present disclosure. One implementation manner of the secure power supply device 202 is shown in FIG. 3, but the present disclosure is not limited thereto. The secure power supply device 202 comprises switches SW1-SW5 and a charge storage capacitor CS. One end of the switch SW1 is electrically connected to the system voltage VDD, and other one end of the switch SW1 is electrically connected to one end of the switch SW2. Other one end of the switch SW2 is configured to output the supply voltage as part or all of the driving voltage VDIG. One end of the switch SW3 is electrically connected to a low voltage (such as a ground voltage), and other one end of the switch SW3 is electrically connected to one end of the switch SW4. Other one end of the switch SW4 is electrically connected to the other one end of the switch SW2. One end of the switch SW5 is electrically connected to one end of the charge storage capacitor CS, and other one end of the switch SW5 is electrically connected to other one end of the charge storage capacitor CS. The switch SW5 is configured as a discharge switch to provide a discharge path, but the switch SW5 is not an essential component in the present disclosure, and can be selectively removed.

The end of the charge storage capacitor CS is electrically connected to the other one end of the switch SW1 and the end of the switch SW2. Also, the other one end of the charge storage capacitor CS is electrically connected to the other one end of the switch SW3 and the end of the switch SW4. The switches SW1-SW4 are controlled by a plurality of second switch signals, and the switch SW5 is controlled by a reset signal. Further, the plurality of second switch signals may be configured to control the charge storage capacitor CS to charge and discharge in the four stages as described in the related art. By the way, the switch SW5 is not an essential component in the present disclosure, and may be selectively removed out from such embodiment. That is, it is not necessary to add the switch SW5 to reset a voltage level of the charge storage capacitor CS, and the reset may be performed by a parasitic discharging path.

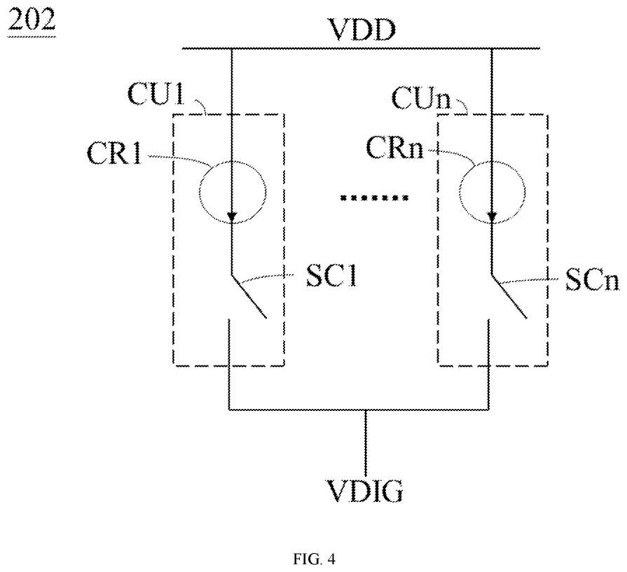

Then, referring to FIG. 4, FIG. 4 is another circuit diagram of a secure power supply device according to an embodiment of the present disclosure. Another implementation manner of the secure supply device 202 is shown in FIG. 3, but the present disclosure is not limited thereto. The secure power supply device 202 comprises a plurality of switching current units CU1-CUn. Further, a plurality of ends of the switching current units CU1-CUn are electrically connected to the system voltage VDD. Also, a plurality of other ends of the switching current units CU1-CUn are electrically connected to each other, and configured to output the supply voltage as part or all of the driving voltage VDIG. The plurality of switching current units CU1-CUn are controlled by the plurality of second switch signals.

The switching current unit CU1 comprises a current source CR1 and a switch SC1. One end of the current source CR1 is electrically connected to the system voltage VDD, one end of the switch SC1 is electrically connected to other one end of the current source CR1, and other one end of the switch SC1 is electrically connected to the driving voltage VDIG. Also, the switch SC1 is controlled by the second switch signals. Similarly, the switching current unit CUn comprises a current source CRn and a switch SCn. As well, the electrical connection manner of the current source CRn and the switch SCn is similar to the electrical connection manner of the current source CR1 and the switch SC1, so it is not repeated here. During encryption/decryption by the encryption/decryption device 22, the driving voltage VDIG decreases, but not lower than the lower limit voltage VTG-Δ, the plurality of switching current units CU1-CUn are controlled by the plurality of the second switch signals to increase the total output current of the plurality of current units CU1-CUn to increase the voltage value of the driving voltage VDIG.

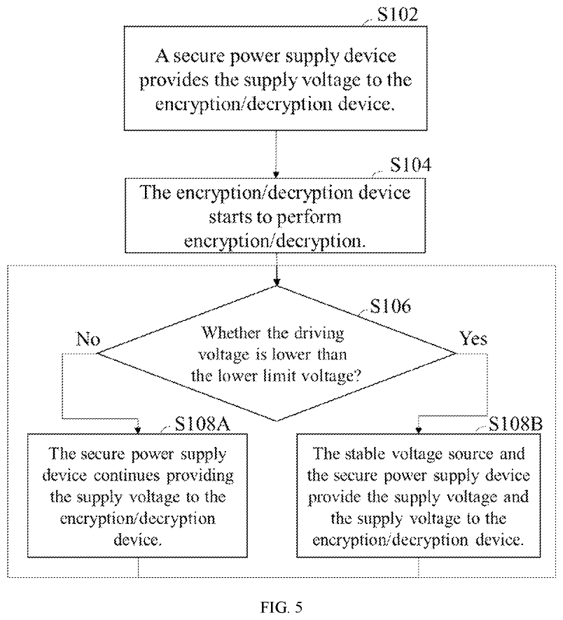

Referred to FIG. 5, FIG. 5 is a flowchart of a power supply method according to an embodiment of the present disclosure. A power supply method is configured to provide power to an encryption/decryption device, which may executed by the preceding power supply devices, and comprises the following steps. Firstly, in step S102, an initial state is provided, and the initial state is that the secure power supply device provides the supply voltage to the encryption/decryption device as the driving voltage. Next, in step S104, the encryption/decryption device starts to perform encryption/decryption. In step S106, whether the driving voltage of the encryption/decryption device is lower than the lower limit voltage is determined. If the driving voltage of the encryption/decryption device is not lower than the lower limit voltage, step S108A is executed. Conversely, if the driving voltage of the encryption/decryption device is lower than the lower limit voltage, step S108B is executed.

In step S108A, since the driving voltage of the encryption/decryption device is not lower than the lower limit voltage, the secure power supply device continues providing the supply voltage to the encryption/decryption device as the driving voltage. In step S108B, since the driving voltage of the encryption/decryption device is lower than the lower limit voltage, the supply voltage of the secure power supply device and the stable voltage provided by the stable voltage source are used as the driving voltage to the encryption/decryption device. Thus, it may be avoided that the encryption/decryption device may not perform encryption/decryption smoothly due to insufficient driving current or driving voltage.

It is should be noted that although the preceding method is limited to select the source of the driving voltage when the encryption/decryption device performs encryption/decryption, the present disclosure is not limited thereto. In other embodiments, regardless of whether encryption or decryption is being performed, when the driving voltage is lower than the lower limit voltage, the stable voltage and the supply voltage are configured as the driving voltage simultaneously.

As the state above, the various power supply devices, the method and the secure system provided by the embodiments of the present disclosure can achieve the technical effects of the preventing hackers from detecting the power pins and the ground pins to obtain secure information. Moreover, compared with the related art, the various power supply device, the method and the secure system provided by the embodiments of the present disclosure may also effectively reduce the required size, operation time, power consumption current and circuit area of the charge storage capacitor. Additionally, it should be mentioned that the system complexity of the various power supply devices, the method and the secure system provided by the embodiments of the present disclosure is not high, so it is easy to implement and does not require huge manufacturing costs. As a result, the various power supply devices, the method and the secure system provided by the embodiments of the present disclosure have extremely high practicability and market value.

It should be understand that the examples and the embodiments described herein are for illustrative purpose only, and various modifications or changes in view of them will be suggested to those skilled in the art, and will be included in the spirit and scope of the application and the appendix with the scope of the claims.

What is claimed is:

1. A power supply device, configured to provide power to an encryption/decryption device of a secure system, comprising:
a secure power supply device, configured to provide a supply voltage based on a system voltage;
a stable voltage source, configured to provide a stable voltage; and
a voltage selection device, electrically connected to the encryption/decryption device, the secure power supply device and the stable voltage source, wherein the voltage selection device is configured to select both of the stable voltage and the supply voltage as a driving voltage of the encryption/decryption device when the driving voltage of the encryption/decryption device is lower than a lower limit voltage, and configured to select the supply voltage as the driving voltage when the driving voltage of the encryption/decryption device is not lower than the lower limit voltage.

2. The power supply device according to claim 1, wherein the voltage selection device comprises:
a voltage detection circuit, electrically connected to the encryption/decryption device, wherein the voltage detection circuit is configured to compare the driving voltage with the lower limit voltage to generate a first switch signal; and
a switch, having a first end, a second end and a control end, wherein the first end is electrically connected to the stable voltage source, the second end is electrically connected to the encryption/decryption device, and the control end is electrically connected to the voltage detection circuit to receive the first switch signal, the first end and the second end are turned on or off based on the first switch signal;
wherein when the first end and the second end are turned on, both of the stable voltage and the supply voltage are received by the encryption/decryption device as the driving voltage, and
when the first end and the second end are turned off, the supply voltage is received by the encryption/decryption device as the driving voltage.

3. The power supply device according to claim 2, wherein the voltage detection circuit is a comparator; wherein
a negative input end of the comparator is configured to receive the driving voltage, a positive input end of the comparator is configured to receive the lower limit voltage, and a voltage value of the lower limit voltage is a target voltage value of the driving voltage minus a difference voltage value.

4. The power supply device according to claim 1, wherein the secure power supply device comprises:
a first switch, a second switch, a third switch, and a fourth switch, wherein one end of the first switch is electrically connected to the system voltage, other one end of the first switch is electrically connected to one end of the second switch, other one end of the second switch is configured to output the supply voltage, one end of the third switch is electrically connected to a low voltage, other one end of the third switch is electrically connected to one end of the fourth switch, and other one end of the fourth switch is electrically connected to the other one end of the third switch; and
a charge storage capacitor, wherein one end of the charge storage capacitor is electrically connected to the other one end of the first switch and the end of the second switch, and other one end of the charge storage capacitor is electrically connected to the other one end of the third switch and the end of the fourth switch;
wherein the first switch, the second switch, the third switch and the fourth switch are controlled by a plurality of second switch signals.

5. The power supply device according to claim 4, wherein the secure power supply device further comprises:
a discharge switch, wherein one end of the discharge switch is electrically connected to the end of the charge storage capacitor, other one end of the discharge switch is electrically connected to the other one end of the charge storage capacitor, and the discharge switch is controlled by a reset signal.

6. The power supply device according to claim 1, wherein the secure power supply device comprises:
a plurality of switching current units, wherein a plurality of ends of the switching current units are electrically connected to the system voltage, and a plurality of other ends of the switching current units are electrically connected to each other and configured to output the supply voltage, and the switching current units are controlled by a plurality of second switch signals.

7. The power supply device according to claim 6, wherein one of the switching current units comprises:
a current source, wherein one end of the current source is electrically connected to the system voltage; and
a switch, wherein one end of the switch is electrically connected to the other one end of the current source, other one end of the switch is electrically connected to the supply voltage, and the switch is controlled by one of the second switch signals.

8. A secure system, comprising:
a power supply device, configured to provide power to an encryption/decryption device of a secure system and comprising:
a secure power supply device, configured to provide a supply voltage based on a system voltage;
a stable voltage source, configured to provide a stable voltage; and
a voltage selection device, electrically connected to the encryption/decryption device, encryption/decryption device and stable voltage source, wherein the voltage selection device is configured to select both of the stable voltage and the supply voltage as a driving voltage of the encryption/decryption device when the driving voltage of the encryption/decryption device is lower than a lower limit voltage, and configured to select the supply voltage as the driving voltage when the driving voltage of the encryption/decryption device is not lower than the lower limit voltage; and
the encryption/decryption device.

9. The secure system according to claim 8, wherein the voltage selection device comprises:
a voltage detection circuit, electrically connected to the encryption/decryption device, wherein the voltage detection circuit is configured to compare the driving voltage with the lower limit voltage to generate a first switch signal; and
a switch, having a first end, a second end and a control end, wherein the first end is electrically connected to the stable voltage source, the second end is electrically connected to the encryption/decryption device, and the control end is electrically connected to the voltage detection circuit to receive the first switch signal,
the first end and the second end are turned on or off based on the first switch signal;
wherein when the first end and the second end are turned on, both of the stable voltage and the supply voltage are received by the encryption/decryption device as the driving voltage, and
when the first end and the second end are turned off, the supply voltage is received by the encryption/decryption device as the driving voltage.

10. The secure system according to claim 9, wherein the voltage detection circuit is a comparator; wherein
a negative input end of the comparator is configured to receive the driving voltage, a positive input end of the comparator is configured to receive the lower limit voltage, and a voltage value of the lower limit voltage is a target voltage value of the driving voltage minus a difference voltage value.

11. The secure system according to claim 8, wherein the secure power supply device comprises:
a first switch, a second switch, a third switch, and a fourth switch, wherein one end of the first switch is electrically connected to the system voltage, other one end of the first switch is electrically connected to one end of the second switch, other one end of the second switch is configured to output the supply voltage, one end of the third switch is electrically connected to a low voltage, other one end of the third switch is electrically connected to one end of the fourth switch, and other one end of the fourth switch is electrically connected to the other one end of the third switch; and
a charge storage capacitor, wherein one end of the charge storage capacitor is electrically connected to the other one end of the first switch and the end of the second switch, and other one end of the charge storage capacitor is electrically connected to the other one end of the third switch and the end of the fourth switch;
wherein the first switch, the second switch, the third switch and the fourth switch are controlled by a plurality of second switch signals.

12. The secure system according to claim 11, wherein the secure power supply device further comprises:
a discharge switch, wherein one end of the discharge switch is electrically connected to the end of the charge storage capacitor, other one end of the discharge switch is electrically connected to other one end of the charge storage capacitor, and the discharge switch is controlled by a reset signal.

13. The secure system according to claim 8, wherein the secure power supply device comprises:
a plurality of switching current units, wherein a plurality of ends of the switching current units are electrically connected to the system voltage, and a plurality of other ends of the switching current units are electrically connected to each other and configured to output the supply voltage, and the switching current units are controlled by a plurality of second switch signals.

14. The secure system according to claim 13, wherein one of the switching current units comprises:
a current source, wherein one end of the current source is electrically connected to the system voltage; and
a switch, wherein one end of the switch is electrically connected to other one end of the current source, other one end of the switch is electrically connected to the supply voltage, and the switch is controlled by one of the second switch signals.

15. A power supply device, configured to provide power to an encryption/decryption device of a secure system, comprising:
a secure power supply device, configured to provide a supply voltage based on a system voltage;
a stable voltage source, configured to provide a stable voltage; and
a voltage selection device, electrically connected to the encryption/decryption device, the secure power supply device and the stable voltage source, wherein the voltage selection device is configured to select the stable voltage as a driving voltage of the encryption/decryption device when the driving voltage of the encryption/decryption device is lower than a lower limit voltage, and configured to select the supply voltage as the driving voltage when the driving voltage of the encryption/decryption device is not lower than the lower limit voltage.
